(19) United States
(12) Patent Application Publication
(10) Pub. No.: US 2010/0059507 A1
(43) Pub. Date: Mar. 11, 2010

(54) APPARATUS FOR HEAT TREATING METALS AND HEAT TREATMENT METHOD

(75) Inventor: Ga-Lane Chen, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/417,797

(22) Filed: Apr. 3, 2009

(30) Foreign Application Priority Data
Sep. 11, 2008 (CN) 200810304471.6

(51) Int. Cl. H05B 6/04; F27D 11/00

(52) U.S. Cl. 219/660; 219/438

(57) ABSTRACT

An apparatus for heat treating metals includes a container configured for receiving a metal therein for heat treatment, a first power supply configured for generating a first electric field and applying a first voltage U₁ represented by a following formula:

$${U}_{1} = \{ \begin{matrix}{u}_{1} cos ( 2 π f t ) ( ( 2 n + 1 / 2 ) π \leq 2 π f t \leq ( 2 n + 3 / 2 ) π ) - \\ {u}_{2} ( 2 n π < 2 π f t \leq ( 2 n + 1 / 2 ) π , ( 2 n + 3 / 2 ) π \leq 2 π f t \leq ( 2 n + 2 ) π ) ,\end{matrix}$$

and a second power supply configured for generating a second electric field having opposite direction to the first electric field applying a second voltage U₂ represented by a following formula:

$${U}_{2} = \{ \begin{matrix}- {u}_{1} cos ( 2 π f t ) ( \begin{matrix}2 n π < 2 π f t \leq ( 2 n + 1 / 2 ) π , \\ ( 2 n + 3 / 2 ) π \leq 2 π f t \leq ( 2 n + 2 ) π\end{matrix} ) \\ {u}_{2} ( ( 2 n + 1 / 2 ) π \leq 2 π f t \leq ( 2 n + 3 / 2 ) π ) ,\end{matrix}$$

wherein n represents integer great than or equal to 0, u₁ is in a range from 50 Volts to 1000 Volts, u₂ is in a range from 25 Volts to 50 Volts, f represents frequency in range from 10⁴ Hz to 10⁶ Hz, and t represents time.

### BACKGROUND

1. Technical Field

The present disclosure relates to a heat treatment apparatus, and particularly, to an apparatus for heat treating metals and a heat treatment method.

2. Description of Related Art

Melting and casting metal are two key processes for preparing metal such as magnesium, aluminum or magnesium-aluminum alloy. In the typical casting process, a molten metal formed in melting process is usually poured into a hollow cavity of a mold, and then solidified. The solidification of molten metal creates nucleation and grain-growth in molten metal, thereby forming the metal having a corresponding microstructure.

During nucleation and grain-growth process, neighboring grains may interact with each. The interaction consequently generates an internal stress at a grain boundary between two neighboring grains. Such internal stress is difficult to avoid in the solidification process. The internal stress is strong enough to lead to deteriorate properties of the metal, for example, degradation of tenacity and plasticity. As a result, a number of micro-cracks may easily occur in and on the metal.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of an apparatus according to a first embodiment.

FIG. 2 is a schematic, cross-sectional view of an apparatus according to a second embodiment.

### DETAILED DESCRIPTION

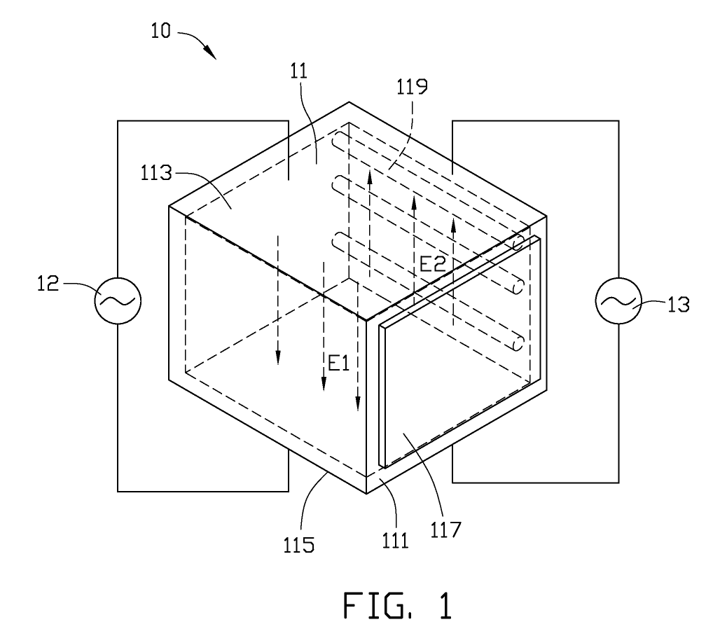

Referring to FIG. 1, an apparatus 10 for heat treating of metals, in accordance with a first embodiment, includes a container 11, a first power supply 12 and a second power supply 13. The first and second power supplies 12, 13 are electrically coupled to the container 11.

The container 11 performs functions of heating and heat preservation, such as a heat treating vacuum furnace, an annealing furnace, and is capable of receiving and heating metals therein. The container 11 has a side wall 111, a top wall 113, a bottom wall 115 opposite to the top wall 113, and a door 117 in the side wall 111. The side wall 111 defines an opening (not labeled) corresponding to the door 117. When the door 117 is closed, the opening of the side wall 111 is obturated by the door 117. The side wall 111 and the door 117 cooperatively define an airproof space to receive the metals.

In this embodiment, the container 11 includes a vacuum heating chamber (not labeled) and a plurality of heating tubes 119. When in use, protecting gases fill the vacuum heating chamber to avoid oxidation of the metal therein. The protecting gases can be selected from the group consisting of inert gases (such as argon) and nitrogen. Each of the heating tubes 119 can be a quartz tube (such as a satin silica glass tube) mounted on the inner surface of the side wall 111. The quartz tube can absorb radiation of visible and near infrared rays from heating material, then the visible and near infrared rays are transformed into far infrared radiation, and the far infrared radiation enables the vacuum heating chamber of the container 11 to obtain the desired high temperature. The container 11 can also includes a heating resistance and other heating elements therein.

A first power supply 12 is configured for generating a first electric field El and applying a first voltage U, represented by a following formula:

$${U}_{1} = \{ \begin{matrix}{u}_{1} cos ( 2 π f t ) ( ( 2 n + 1 / 2 ) π \leq 2 π f t \leq ( 2 n + 3 / 2 ) π ) - \\ {u}_{2} ( 2 n π < 2 π f t \leq ( 2 n + 1 / 2 ) π , ( 2 n + 3 / 2 ) π \leq 2 π f t \leq ( 2 n + 2 ) π ) ,\end{matrix}$$

wherein n represents integer greater than or equal to 0, u₁ is in a range from 50 Volts to 1000 Volts, u₂ is in a range from 25 Volts to 50 Volts, f represents frequency in a range from 10⁴ Hz to 10⁶ Hz, and t represents time. A direction of the first electric field E₁ is from the top wall 113 to the bottom wall 115. In the first embodiment, the direction of the first electric field E₁ is perpendicular to a maximum surface of the metal to achieve a uniformity of electric field influence on the metal. The anode and negative electrodes of the first power supply 12 are electrically connected to the top wall 113 and the bottom wall 115, respectively.

The second power supply 13 is similar to the first power supply 12, and configured for generating a second electric field E₂ and applying a first voltage U₂ represented by a following formula:

$${U}_{2} = \{ \begin{matrix}- {u}_{1} cos ( 2 π f t ) ( \begin{matrix}2 n π < 2 π f t \leq ( 2 n + 1 / 2 ) π , \\ ( 2 n + 3 / 2 ) π \leq 2 π f t \leq ( 2 n + 2 ) π\end{matrix} ) \\ {u}_{2} ( ( 2 n + 1 / 2 ) π \leq 2 π f t \leq ( 2 n + 3 / 2 ) π ) ,\end{matrix}$$

wherein n represents integer great than or equal to 0, u₁ is in a range from 50 Volts to 1000 Volts, u₂ is in a range from 25 Volts to 50 Volts, f represents frequency in a range from 10⁴ Hz to 10⁶ Hz, and t represents time. A 180 degrees phase shift appears between the first and second electric field E₁, E₂. The anode and negative electrodes of the second power supply 13 are electrically connected to the bottom wall 115 and the top wall 113, respectively. A direction of the second electric field E₂ is in the opposite direction of the first electric field E₁.

In heat treatment process, the first and second power supplies 12,13 simultaneously generate two opposite respective electric fields E₁ and E₂ to treat the metals. For example, when the apparatus 10 is applied for heat treatment of a magnesium alloy, a temperature of the container 11 is raised to a desired temperature in a range from 100 to 200 Celsius degree. The u₁ of the first and second power supplies 12, 13 is in a range from 150 Volts to 500 Volts, and the f represents frequency in range from 4×10⁴ Hz to 4×10⁶ Hz. In such way, the internal stresses having opposite directions of the magnesium alloy are removed, and the magnesium alloy can achieve better physical properties (e.g. tenacity and plasticity). The first and second power supplies 12, 13 can also generate two opposite respective electric fields E₁ and E₂ alternatively.

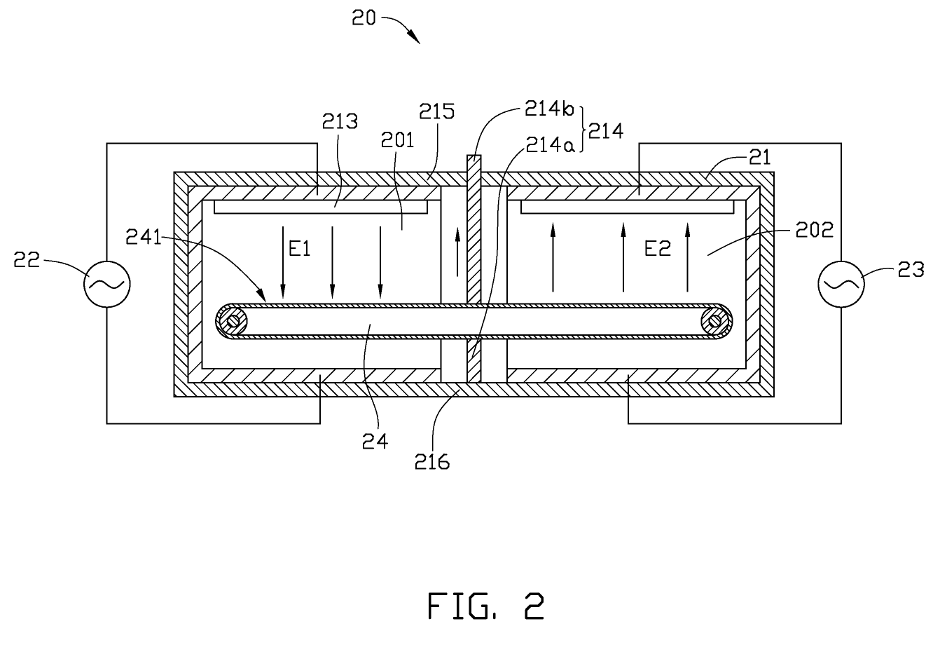

Referring to FIG. 2, an apparatus 20 for heat treating metals, according to a second embodiment, is similar to the apparatus 10 of the first embodiment in structure, except for first and second power supplies 22, 23.

In this embodiment, the container 21 has a first process chamber 201 and a second process chamber 202 in communication with the first process chamber 201. The first and second power supplies 22, 23 respectively generate a first electric field E₁ in the first and second process chambers 201, 202. A direction of the second electric field E₂ is in the opposite direction of the first electric field E₁. In working process, a temperature in the first chamber 201 is same as a temperature in the second chamber 202.

The apparatus 20 also includes a supporting member 24. One part of the supporting member 24 is positioned in the first process chamber 201, and another part of the supporting member 24 is positioned in the second process chamber 202. The supporting member 24 is configured for supporting and driving the metals to move in the container 21. The supporting member 24 can move along two opposite directions to bring the metals to move between the first chamber 201 and the second chamber 202. That is to say, the metals can enter into or exit out of the first chamber 201 or the second chamber 202. In this embodiment, the supporting member 24 is a conveyer belt made of refractory metal. A portion of the conveyer belt is located in the first chamber 201, and another portion of the conveyer belt is located in the second chamber 202. The supporting member 24 includes a supporting surface 241 configured for supporting the metals thereon. The supporting surface 241 is positioned facing the quartz tube 213 allowing the metals to be heated evenly.

The velocity of the supporting member 24 depends on a direction of electric field, a value of the electric field, time of heat treatment and change periods of the first and second power supplies 21, 22 to ensure effective heat treatment of metal.

In this embodiment, the apparatus 20 also includes a intermediate plate 214 between the first and second chambers 201, 202 to separate the first and second chambers 201, 202 from each other. The intermediate plate 214 is configured for preventing mutual interference of the first and the second electric field E₁ and E₂. The intermediate plate 214 may be made of electromagnetic shield material, such as ferronickel alloy, electrically conductive plastic, surface conductive material, electrically conductive glass, and etc.

The intermediate plate 214 includes a fixed portion 214a and a movable portion 214a. One end of the fixed portion 214a is fixed on the inner surface of the bottom wall 216, and another end of the fixed portion 214a is adjacent to the supporting member 24. The movable portion 214b movably goes through the top wall 215 of the container 21, and can be close to or far away from the supporting surface 214.

In working process, the moving portion 214b is far away from the supporting surface 214. The metals placed on the supporting surface 214 can be firstly treated by the first electric field E₁, and then moved by the supporting member 24 to the second chamber 202 to be treated by the second electric field E₂. Meanwhile, the moving portion 214b is close to the supporting surface 214 to prevent mutual interference of the first and the second electric field E₁ and E₂.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An apparatus for heat treating metals, comprising:
a container configured for receiving a metal therein for heat treatment;
a first power supply configured for generating a first electric field and applying a first voltage U₁ represented by a following formula:
$${U}_{1} = \{ \begin{matrix}{u}_{1} cos ( 2 π f t ) ( ( 2 n + 1 / 2 ) π \leq 2 π f t \leq ( 2 n + 3 / 2 ) π ) - \\ {u}_{2} ( 2 n π < 2 π f t \leq ( 2 n + 1 / 2 ) π , ( 2 n + 3 / 2 ) π \leq 2 π f t \leq ( 2 n + 2 ) π ) ,\end{matrix}$$
a second power supply configured for generating a second electric field having opposite direction to the first electric field applying a second voltage U₂ represented by a following formula:
$${U}_{2} = \{ \begin{matrix}- {u}_{1} cos ( 2 π f t ) ( \begin{matrix}2 n π < 2 π f t \leq ( 2 n + 1 / 2 ) π , \\ ( 2 n + 3 / 2 ) π \leq 2 π f t \leq ( 2 n + 2 ) π\end{matrix} ) \\ {u}_{2} ( ( 2 n + 1 / 2 ) π \leq 2 π f t \leq ( 2 n + 3 / 2 ) π )\end{matrix}$$
wherein n represents integer great than or equal to 0, u₁ is in a range from 50 Volts to 1000 Volts, u₂ is in a range from 25 Volts to 50 Volts, f represents frequency in range from 10⁴ Hz to 10⁶ Hz, and t represents time.

2. The apparatus as claimed in claim 1, wherein the u₁ is in a range from 150 Volts to 500 Volts, f is in range from 4×10⁴ Hz to 4×10⁶ Hz.

3. The apparatus as claimed in claim 1, wherein the first and second power supplies respectively generate the first and second electric fields in the container at the same time.

4. The apparatus as claimed in claim 1, wherein the first and second power supplies respectively generate the first and second electric fields in the container alternately.

5. The apparatus as claimed in claim 1, further comprising a supporting member movably installed in the container, the container comprising a first process chamber and a second process chamber in communication with the first process chamber, the first power supply being electrically coupled to the first process chamber, the second power supply being couple to the second process chamber, the supporting member configured for driving the metal thereon to move between the first and second process chambers.

6. The apparatus as claimed in claim 5, further comprising an intermediate plate between the first and second process chambers to separate the first and second process chambers from each other.

7. The apparatus as claimed in claim 5, the container is a vacuum container.

8. A heat treatment method, comprising: proving an apparatus for heat treating metals, the apparatus comprising a container configured for receiving a metal therein for heat treatment, a first power apply configured for generating a first electric field and applying a first voltage U₁ represented by a following formula:
$${U}_{1} = \{ \begin{matrix}{u}_{1} cos ( 2 π f t ) ( ( 2 n + 1 / 2 ) π \leq 2 π f t \leq ( 2 n + 3 / 2 ) π ) - \\ {u}_{2} ( 2 n π < 2 π f t \leq ( 2 n + 1 / 2 ) π , ( 2 n + 3 / 2 ) π \leq 2 π f t \leq ( 2 n + 2 ) π ) ,\end{matrix}$$
and a second power apply configured for generating a second electric field having opposite direction to the first electric field applying a second voltage U₂ represented by a following formula:
$${U}_{2} = \{ \begin{matrix}- {u}_{1} cos ( 2 π f t ) ( \begin{matrix}2 n π < 2 π f t \leq ( 2 n + 1 / 2 ) π , \\ ( 2 n + 3 / 2 ) π \leq 2 π f t \leq ( 2 n + 2 ) π\end{matrix} ) \\ {u}_{2} ( ( 2 n + 1 / 2 ) π \leq 2 π f t \leq ( 2 n + 3 / 2 ) π )\end{matrix}$$
wherein n represents integer great than or equal to 0, u₁ is in a range from 50 Volts to 1000 Volts, u₂ is in a range from 25 Volts to 50 Volts, f represents frequency in range from 10⁴ Hz to 10⁶ Hz, and t represents time;
raising a temperature of the container to a desired temperature and heating the metal therein;
turning on the first and second power supplies to generate two electric fields having opposite direction to treat the metal.

9. The method as claimed in claim 8, further comprising a step of inputting protecting gases in the container before raising a temperature of the container.

10. The method as claimed in claim 9, wherein the protecting air is selected from the group consisting of inert gases and nitrogen.

11. The method as claimed in claim 8, wherein the first and second power supplies respectively generate the first and second electric fields in the heat container at the same time.

12. The method as claimed in claim 8, wherein the first and second power supplies respectively generate the first and second electric fields in the container alternately.
